(19) United States
(12) Patent Application Publication
(10) Pub. No.: US 2014/0280620 A1
(43) Pub. Date: Sep. 18, 2014

(54) COMMUNICATION SYSTEM WITH IDENTIFICATION MANAGEMENT AND METHOD OF OPERATION THEREOF

(71) Applicant: SAMSUNG ELECTRONICS CO., LTD., Gyeonggi-Do (KR)

(72) Inventors: Seungeun Lee, Sunnyvale, CA (US); Justin Gregg, Golden, CO (US)

(73) Assignee: SAMSUNG ELECTRONICS CO., LTD., Gyeonggi-Do (KR)

(21) Appl. No.: 13/832,976

(22) Filed: Mar. 15, 2013

(51) Int. Cl. H04L 12/58

(52) U.S. Cl. CPC H04L 51/10
USPC 709/206

(57) ABSTRACT

A method of operation of a communication system includes: an identifier classification module configured to determine a media classification associated with a sender identifier; a contact assignment module, coupled to the identifier classification module, configured to associate the sender identifier with a contact entry based on context information; and an identifier transmission module, coupled to the contact assignment module, configured to transmit the sender identifier based on the media classification corresponding to a transmission condition for displaying on a device.

### TECHNICAL FIELD

An embodiment of the present invention relates generally to a communication system, and more particularly to a system with identification management mechanism.

### BACKGROUND ART

Modern portable consumer and industrial electronics, especially client devices such as communication systems, cellular phones, portable digital assistants, and combination devices, are providing increasing levels of functionality to support modern life including communication services. Research and development in the existing technologies can take a myriad of different directions.

As users become more empowered with the growth of communication service devices, new and old paradigms begin to take advantage of this new device space. There are many technological solutions to take advantage of this new device location opportunity. One existing approach is to evaluate user profile and location information to provide personalized communication through a mobile device such as a cell phone, a smart phone, or a personal digital assistant.

Personalized communication services allow users to create, transfer, store, and/or consume information in order for users to create, transfer, store, and consume in the “real world.” One such use of personalized communication services is to efficiently connect different users through communication devices.

Communication systems and personalized communication services enabled systems have been incorporated in automobiles, notebooks, handheld devices, wearable digital devices, and other portable products. Today, these systems aid users by incorporating available, real-time relevant information, such as advertisement, entertainment, local businesses, or other points of interest (POI).

However, a communication system with an identification mechanism has become a paramount concern for the consumer. The inability decreases the benefit of using the tool.

Thus, a need still remains for a communication system with identification mechanism for identifying a sender of a message. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a communication system, including: an identifier classification module for determining a media classification associated with a sender identifier; a contact assignment module, coupled to the identifier classification module, for associating the sender identifier with a contact entry based on context information; and an identifier transmission module, coupled to the contact assignment module, for transmitting the sender identifier based on the media classification corresponding to a transmission condition for displaying on a device.

An embodiment of the present invention provides a method of operation of a communication system including: determining a media classification associated with a sender identifier; associating the sender identifier with a contact entry based on context information; and transmitting the sender identifier based on the media classification corresponding to a transmission condition for displaying on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a communication system with identification management mechanism in an embodiment of the present invention.

FIG. 2 is a display interface of the first device of the communication system.

FIG. 3 is an example of communication initiation between the first device and the second device of the communication system.

FIG. 4 is an exemplary block diagram of the communication system.

FIG. 5 is a control flow of the communication system.

FIG. 6 is a flow chart of a method of operation of the communication system of FIG. 1 in a further embodiment of the present invention.

### DETAILED DESCRIPTION

An embodiment of the present invention can associate the sender identifier based on context information surrounding the message sender, the message receiver, or a combination thereof. By determining the context information of the message sender, the message receiver, or a combination thereof, an embodiment of the present invention can accurately identify the sender identifier most suited for displaying on the first device. Customizing the sender identifier according to the context enhances the user experience of using the first device.

An embodiment of the present invention provides the sender content rating for the sender identifier for improved categorization of the sender identifier for transmission to the message receiver. An embodiment of the present invention can accurately transmit the sender identifier for improving the user experience of the first device.

An embodiment of the present invention can transmit the sender identifier most appropriate to the message receiver based on comparing the sender content rating to the content threshold. By comparing the sender content rating to the content threshold, an embodiment of the present invention can accurately determine the sender identifier most suited for displaying on the first device. Customizing the sender identifier based on the permitted content enhances the user experience of using the first device.

An embodiment of the present invention provide a receiver condition verification to improve communication between the message sender and message receiver by preventing or allowing transmission of the sender identifier when the receiver conditions are satisfied. An embodiment of the present invention can transmit the sender identifier efficiently for the improved user experience for using the first device.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention. Where multiple embodiments are disclosed and described having some features in common, for clarity and ease of illustration, description, and comprehension thereof, similar and like features one to another will ordinarily be described with similar reference numerals.

The term “user experience” encompasses a user's perceptions of the practical aspects such as utility, ease of use, and efficiency of an embodiment of the present invention. The term “relevant information” referred to herein includes the contextual information described as well as information relating to points of interest to the user, such as local business, hours of businesses, types of businesses, timeline, advertised specials, social information, maps, local events, and nearby community or personal information.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

Referring now to FIG. 1, therein is shown is a communication system 100 with identification management mechanism in an embodiment of the present invention. The communication system 100 includes a first device 102, such as a client or a server, connected to a second device 106, such as a client or server, with a communication path 104, such as a wireless or wired network.

For example, the first device 102 can be of any of a variety of mobile devices, such as a cellular phone, personal digital assistant, wearable digital device, a notebook computer, television (TV), automotive telematic communication system, or other multi-functional mobile communication or entertainment device. The first device 102 can be a standalone device, or can be incorporated with a vehicle, for example a car, truck, bus, aircraft, boat/vessel, or train. The first device 102 can couple to the communication path 104 to communicate with the second device 106.

For illustrative purposes, the communication system 100 is described with the first device 102 as a mobile computing device, although it is understood that the first device 102 can be different types of computing devices. For example, the first device 102 can also be a non-mobile computing device, such as a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, Android™ smartphone, or Windows™ platform smartphone.

For illustrative purposes, the communication system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, aircraft, boat/vessel, or train.

Also for illustrative purposes, the communication system 100 is shown with the second device 106 and the first device 102 as end points of the communication path 104, although it is understood that the communication system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, wireless High-Definition Multimedia Interface (HDMI), Near Field Communication (NFC), Infrared Data Association standard (IrDA), wireless fidelity (WiFi), and worldwide interoperability for microwave access (WiMAX) are examples of wireless communication that can be included in the communication path 104. Ethernet, HDMI, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

Referring now to FIG. 2, therein is shown a display interface 202 of the first device 102 of the communication system 100. As an example, the first device 102 can be a sender device for a message sender 210. The sender device can be a device used to send or receive communication from the devices of other users. The message sender 210 is defined as the user of a device who initiates communication with another user through another device.

The display interface 202 depicts contact entries 212 in a contact list 216. The contact entries 212 are defined as information associated with the receiver of a message or communication. For example, the contact entries 212 can include contact information 214, such as telephone numbers, email addresses, residential addresses, personal information, including relationship to the message sender 210 or birthdays, uniform resource locator (URL) for social network site (SNS), preferences of a receiver of the message, or a combination thereof.

The contact entries 212 can display or include a sender identifier 218. The sender identifier 218 is defined as a video or motion graphic associated with the initiator of the communication. The sender identifier 218 can be a motion media 208 selected by the message sender 210 for displaying on a device of another user. For example, the sender identifier 218 can be a video, multimedia, or animated ring tone.

The motion media 208 is defined as a motion graphic or animated graphic. For example, the motion media 208 can be a video clip from a movie, a television show, a computer generated animated avatar, multimedia file, or recording generated by a user, such as the message sender 210.

Referring now to FIG. 3, therein is shown an example of communication initiation 324 between the first device 102 and the second device 106 of the communication system 100. As an example, the communication initiation 324 can represent interactions between two instances of the first device 102. For example, John, the message sender 210, can operate the first instance of the first device 102. Further, Jane, a message receiver 320 can operate the second instance of the first device 102. The message receiver 320 is defined as the user of a device receiving communication initiated by another user.

For illustrative purposes, the first device 102 is shown as the receiver device for clarity. However, it is understood that other device can be the receiver device. For example, the receiver device can be the second device 106 of FIG. 1. As a further example, the second device 106 can be a type of device such as the first device 102.

The communication initiation 324 can occur when the first device 102 operated by the message sender 210 generates and transmits a notification to the first device 102 operated by the message receiver 320 for initiating communication, such as when the telephone or mobile device provides a communication notification. The communication initiation 324 can include transmission of the sender identifier 218 of the message sender 210. The sender identifier 218 can be displayed on the display interface 202 of the second device 106 during the period of the communication initiation 324.

The sender identifier 218 can be transmitted to the second instance of the first device 102 directly from the first instance of the first device 102 or indirectly from the first device 102 through the second device 106, such as data or information storage server. For example, the second device 106 can be such a social media website, such as Facebook™, Google+™, YouTube™, or other internet based services.

For a different example, the second device 106 can represent the cloud computing server. The second device 106 can store the sender identifier 218 set by the message sender 210, the message receiver 320, or a combination thereof.

For example, the second device 106 can link the sender identifier 218 to be displayed on the first device 102 of the message receiver 320. More specifically, when the message sender 210 initiates communication to the message receiver 320, the second device 106 can transmit the sender identifier 218 set by the message sender 210 for displaying on the first device 102 of the message receiver 320.

For further example, the message sender 210 can update the sender identifier 218 stored on the second device 106. When the message sender 210 initiates communication to the message receiver 320 subsequent to the update, the second device 106 can transmit the sender identifier 218 updated by the message sender 210 for displaying on the first device 102 of the message receiver 320.

For a different example, the message receiver 320 can set the sender identifier 218 similarly to the message sender 210 setting the sender identifier 218. More specifically, the message receiver 320 can set the sender identifier 218 to represent the particular individual of the message sender 210. For example, if the message sender 210 is John, the message receiver 320, Jane, can set the sender identifier 218 to be the multimedia file representing a video clip of John playing basketball. The second device 102 can transmit the sender identifier 218 representing the video clip to be displayed on the first device 102 operated by Jane when John initiates communication with Jane.

For another example, the second device 106 can set the sender identifier 218 based on context information 326 for displaying on the first device 102. The context information 326 can represent information relevant, surrounding, or a combination thereof to the message sender 210, the message receiver 324, or a combination thereof. For example, the context information 326 can represent social graph of SNS, geographic information 328 of the message sender 210 of the message receiver 324, or a combination thereof. The geographic information 328 can represent the location information.

For further example, the context information 326 can represent an office setting. If the message sender 210 is within an office setting, the second device 102 can transmit the sender identifier 218 representing a digital photograph of the message sender 210 in a business attire to be displayed on the first device 102 of the message receiver 320. If the message sender 210 is at a basketball court, the second device 106 can transmit the sender identifier 218 representing the video clip of the message sender 210 playing basketball to be displayed on the first device 102 of the message receiver 320. Details regarding the linking and dynamic setting of the setting of the sender identifier 218 below.

Referring now to FIG. 4, therein is an exemplary block diagram of the communication system 100. The communication system 100 can include a first device 102, a communication path 104, and a second device 106.

The first device 102 can communicate with the second device 106 over the communication path 104. The screen shot shown on the display interface 202 described in FIG. 2 can represent the screen shot for the communication system 100.

The first device 102 can send information in a first device transmission 408 over the communication path 104 to the second device 106. The second device 106 can send information in a second device transmission 410 over the communication path 104 to the first device 102.

For illustrative purposes, the communication system 100 is shown with the first device 102 as a client device, although it is understood that the communication system 100 can have the first device 102 as a different type of device. For example, the first device 102 can be a server.

Also for illustrative purposes, the communication system 100 is shown with the second device 106 as a server, although it is understood that the communication system 100 can have the second device 106 as a different type of device. For example, the second device 106 can be a client device.

For brevity of description in this embodiment of the present invention, the first device 102 will be described as a client device and the second device 106 will be described as a server device. An embodiment of the present invention is not limited to this selection for the type of devices. The selection is an example of an embodiment of the present invention.

The first device 102 can include a first control unit 412, a first storage unit 414, a first communication unit 416, and a first user interface 418. The first control unit 412 can include a first control interface 422. The first control unit 412 can execute a first software 426 to provide the intelligence of the communication system 100.

The first control unit 412 can be implemented in a number of different manners. For example, the first control unit 412 can be a processor, an embedded processor, a microprocessor, a hardware control logic, a hardware finite state machine (FSM), a digital signal processor (DSP), or a combination thereof. The first control interface 422 can be used for communication between the first control unit 412 and other functional units in the first device 102. The first control interface 422 can also be used for communication that is external to the first device 102.

The first control interface 422 can receive information from the other functional units or from external sources, or can transmit information to the other functional units or to external destinations. The external sources and the external destinations refer to sources and destinations external to the first device 102.

The first control interface 422 can be implemented in different ways and can include different implementations depending on which functional units or external units are being interfaced with the first control interface 422. For example, the first control interface 422 can be implemented with a pressure sensor, an inertial sensor, a microelectromechanical system (MEMS), optical circuitry, waveguides, wireless circuitry, wireline circuitry, or a combination thereof.

The first device 102 can include a location unit 420. The location unit 420 can generate location information, current heading, and current speed of the first device 102, as examples. The location unit 420 can be implemented in many ways. For example, the location unit 420 can function as at least a part of a global positioning system (GPS), an inertial navigation system, a cellular-tower location system, a pressure location system, or any combination thereof.

The location unit 420 can include a location interface 432. The location interface 432 can be used for communication between the location unit 420 and other functional units in the first device 102. The location interface 432 can also be used for communication that is external to the first device 102.

The location interface 432 can receive information from the other functional units or from external sources, or can transmit information to the other functional units or to external destinations. The external sources and the external destinations refer to sources and destinations physically separate from the first device 102.

The location interface 432 can include different implementations depending on which functional units or external units are being interfaced with the location unit 420. The location interface 432 can be implemented with technologies and techniques similar to the implementation of the first control interface 422.

The first storage unit 414 can store the first software 426. The first storage unit 414 can also store the relevant information, such as advertisements, points of interest (POI), navigation routing entries, push-information, or any combination thereof.

The first storage unit 414 can be a volatile memory, a nonvolatile memory, an internal memory, an external memory, or a combination thereof. For example, the first storage unit 414 can be a nonvolatile storage such as non-volatile random access memory (NVRAM), Flash memory, disk storage, or a volatile storage such as static random access memory (SRAM).

The first storage unit 414 can include a first storage interface 424. The first storage interface 424 can be used for communication between functional units in the first device 102. The first storage interface 424 can also be used for communication that is external to the first device 102.

The first storage interface 424 can receive information from the other functional units or from external sources, or can transmit information to the other functional units or to external destinations. The external sources and the external destinations refer to sources and destinations external to the first device 102.

The first storage interface 424 can include different implementations depending on which functional units or external units are being interfaced with the first storage unit 414. The first storage interface 424 can be implemented with technologies and techniques similar to the implementation of the first control interface 422.

The first communication unit 416 can enable external communication to and from the first device 102. For example, the first communication unit 416 can permit the first device 102 to communicate with the second device 106 of FIG. 1, an attachment, such as a peripheral device or a computer desktop, and the communication path 104.

The first communication unit 416 can also function as a communication hub allowing the first device 102 to function as part of the communication path 104 and not limited to be an end point or terminal unit to the communication path 104. The first communication unit 416 can include active and passive components, such as microelectronics or an antenna, for interaction with the communication path 104.

The first communication unit 416 can include a first communication interface 428. The first communication interface 428 can be used for communication between the first communication unit 416 and other functional units in the first device 102. The first communication interface 428 can receive information from the other functional units or can transmit information to the other functional units.

The first communication interface 428 can include different implementations depending on which functional units are being interfaced with the first communication unit 416. The first communication interface 428 can be implemented with technologies and techniques similar to the implementation of the first control interface 422.

The first user interface 418 allows a user (not shown) to interface and interact with the first device 102. The first user interface 418 can include an input device and an output device. Examples of the input device of the first user interface 418 can include a keypad, a touchpad, a touchscreen, a tablet stylus, soft-keys, a keyboard, a microphone, or any combination thereof to provide data and communication inputs.

The first user interface 418 can include a first display interface 430. The first display interface 430 can include a display, a projector, a video screen, a speaker, or any combination thereof.

The first control unit 412 can operate the first user interface 418 to display information generated by the communication system 100. The first control unit 412 can also execute the first software 426 for the other functions of the communication system 100. The first control unit 412 can further execute the first software 426 for interaction with the communication path 104 via the first communication unit 416.

The second device 106 can be optimized for implementing an embodiment of the present invention in a multiple device embodiment with the first device 102. The second device 106 can provide the additional or higher performance processing power compared to the first device 102. The second device 106 can include a second control unit 434, a second communication unit 436, and a second user interface 438.

The second user interface 438 allows a user (not shown) to interface and interact with the second device 106. The second user interface 438 can include an input device and an output device. Examples of the input device of the second user interface 438 can include a keypad, a touchpad, a touchscreen, a tablet stylus, soft-keys, a keyboard, a microphone, or any combination thereof to provide data and communication inputs. Examples of the output device of the second user interface 438 can include a second display interface 440. The second display interface 440 can include a display, a projector, a video screen, a speaker, or any combination thereof.

The second control unit 434 can execute a second software 442 to provide the intelligence of the second device 106 of the communication system 100. The second software 442 can operate in conjunction with the first software 426. The second control unit 434 can provide additional performance compared to the first control unit 412.

The second control unit 434 can operate the second user interface 438 to display information. The second control unit 434 can also execute the second software 442 for the other functions of the communication system 100, including operating the second communication unit 436 to communicate with the first device 102 over the communication path 104.

The second control unit 434 can be implemented in a number of different manners. For example, the second control unit 434 can be a processor, an embedded processor, a microprocessor, a hardware control logic, a hardware finite state machine (FSM), a digital signal processor (DSP), or a combination thereof.

The second control unit 434 can include a second control interface 444. The second control interface 444 can be used for communication between the second control unit 434 and other functional units in the second device 106. The second control interface 444 can also be used for communication that is external to the second device 106.

The second control interface 444 can receive information from the other functional units or from external sources, or can transmit information to the other functional units or to external destinations. The external sources and the external destinations refer to sources and destinations external to the second device 106.

The second control interface 444 can be implemented in different ways and can include different implementations depending on which functional units or external units are being interfaced with the second control interface 444. For example, the second control interface 444 can be implemented with a pressure sensor, an inertial sensor, a microelectromechanical system (MEMS), optical circuitry, waveguides, wireless circuitry, wireline circuitry, or a combination thereof.

A second storage unit 446 can store the second software 442. The second storage unit 446 can also store the relevant information, such as advertisements, points of interest (POI), navigation routing entries, push-information, or any combination thereof. The second storage unit 446 can be sized to provide the additional storage capacity to supplement the first storage unit 414.

For illustrative purposes, the second storage unit 446 is shown as a single element, although it is understood that the second storage unit 446 can be a distribution of storage elements. Also for illustrative purposes, the communication system 100 is shown with the second storage unit 446 as a single hierarchy storage system, although it is understood that the communication system 100 can have the second storage unit 446 in a different configuration. For example, the second storage unit 446 can be formed with different storage technologies forming a memory hierarchal system including different levels of caching, main memory, rotating media, or off-line storage.

The second storage unit 446 can be a volatile memory, a nonvolatile memory, an internal memory, an external memory, or a combination thereof. For example, the second storage unit 446 can be a nonvolatile storage such as non-volatile random access memory (NVRAM), Flash memory, disk storage, or a volatile storage such as static random access memory (SRAM).

The second storage unit 446 can include a second storage interface 448. The second storage interface 448 can be used for communication between functional units in the second device 106. The second storage interface 448 can also be used for communication that is external to the second device 106.

The second storage interface 448 can receive information from the other functional units or from external sources, or can transmit information to the other functional units or to external destinations. The external sources and the external destinations refer to sources and destinations external to the second device 106.

The second storage interface 448 can include different implementations depending on which functional units or external units are being interfaced with the second storage unit 446. The second storage interface 448 can be implemented with technologies and techniques similar to the implementation of the second control interface 444.

The second communication unit 436 can enable external communication to and from the second device 106. For example, the second communication unit 436 can permit the second device 106 to communicate with the first device 102 over the communication path 104.

The second communication unit 436 can also function as a communication hub allowing the second device 106 to function as part of the communication path 104 and not limited to be an end point or terminal unit to the communication path 104. The second communication unit 436 can include active and passive components, such as microelectronics or an antenna, for interaction with the communication path 104.

The second communication unit 436 can include a second communication interface 450. The second communication interface 450 can be used for communication between the second communication unit 436 and other functional units in the second device 106. The second communication interface 450 can receive information from the other functional units or can transmit information to the other functional units.

The second communication interface 450 can include different implementations depending on which functional units are being interfaced with the second communication unit 436. The second communication interface 450 can be implemented with technologies and techniques similar to the implementation of the second control interface 444.

The first communication unit 416 can couple with the communication path 104 to send information to the second device 106 in the first device transmission 408. The second device 106 can receive information in the second communication unit 436 from the first device transmission 408 of the communication path 104.

The second communication unit 436 can couple with the communication path 104 to send information to the first device 102 in the second device transmission 410. The first device 102 can receive information in the first communication unit 416 from the second device transmission 410 of the communication path 104. The communication system 100 can be executed by the first control unit 412, the second control unit 434, or a combination thereof.

For illustrative purposes, the second device 106 is shown with the partition having the second user interface 438, the second storage unit 446, the second control unit 434, and the second communication unit 436, although it is understood that the second device 106 can have a different partition. For example, the second software 442 can be partitioned differently such that some or all of its function can be in the second control unit 434 and the second communication unit 436. Also, the second device 106 can include other functional units not shown in FIG. 4 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the communication system 100 is described by operation of the first device 102 and the second device 106. It is understood that the first device 102 and the second device 106 can operate any of the modules and functions of the communication system 100.

Referring now to FIG. 5, therein is shown a control flow of the communication system 100. The communication system 100 can include an identification management module 550, a communication initiation module 566, and an identifier transmission module 572. The identification management module 550 can be coupled to the communication initiation module 566, the identifier transmission module 572, or a combination thereof.

The identification management module 550 is for designating media as a communication identifier and for determining classifications of the communication identifier. The identification management module 550 can designate the motion media 208 as the sender identifier 218 with a media select module 552. The identification management module 550 can include the media select module 552.

The media select module 552 is for selecting media as the identifier of the user. For example, the media select module 552 can select the motion media 208 as the sender identifier 218 for displaying on the second device 106 of FIG. 1. As a specific example, the media select module 552 can enable the message sender 210 of FIG. 2 to select the motion media 208 as the sender identifier 218. The sender identifier 218 can be stored on the first device 102 of FIG. 2, the second device 106 of FIG. 3, or a combination thereof.

The media select module 552 can select the motion media 208 in a number of different ways. For example, the message sender 210 can designate the motion media 208 generated by the message sender 210 as the sender identifier 218. In another example, the message receiver 320 of FIG. 3 can designate the motion media 208 received from sources external to the first device 102 as the sender identifier 218.

In yet another example, the media select module 552 can add meta data to the motion media 208 to identify the motion media 208 as the sender identifier 218. More specifically, the meta data can represent a category of the sender identifier 218. For a specific example, the sender identifier 218 can be categorized into “family,” “business,” “friend,” or a combination thereof. In yet a further example, the sender identifier 218 can be selected as multiple ones of the motion media 208 with a dynamic URL. In yet a further example, the media select module 552 can associate the motion media 208 as one or more of the motion media 208 on a web page, such as videos on a social media website, including Facebook™ or Myspace™.

The identification management module 550 can include an identifier classification module 554, coupled to the media select module 552. The identifier classification module 554 is for associating the communication identification with information associated with a contact and for determining a rating for the identifier. The identifier classification module 554 can enable assignment of a media classification 556 for the sender identifier 218.

The media classification 556 is defined as classification based on the content of the media and contact associations to the sender of the communication identifier. The media classification 556 can include a contact classification 558 and a sender content rating 560.

The contact classification 558 is defined a designation of contacts eligible to receive the communication identifier of the sender of the message. For example, the contact classification 558 can be based on specific ones of the contact entries 212 of FIG. 2 or a group of the contact entries 212 in the contact list 216 of FIG. 2 that are designated by the message sender 210.

The sender content rating 560 is defined as a rating of the content of the media. For example, the sender content rating 560 can be based on a standard or universal rating system, such as the Motion Picture Association of America (MPAA) rating system, the Entertainment Software Rating Board (ESRB) rating system, or a rating system generated by the message sender 210.

The identification management module 550 can determine the contact classification 558 of the sender identifier 218 with a contact assignment module 562. The contact assignment module 562 can determine the contact classification 558 in a number of different ways. For example, the contact assignment module 562 can enable the message sender 210 to manually associate the sender identifier 218 with the contact entries 212 for one or more of the message receiver 320 in the contact list 216.

As another example, the contact assignment module 562 can automatically associate the sender identifier 218 with the contact entries 212 in the contact list 216 based on the context information 326 of FIG. 3. For example, the contact assignment module 562 can use the context information 326, such as a social graph, to automatically determine the relationships between the message sender 210 and each one of the contact entries 212 in the contact list 216. The social graph can be a graph or chart that defines the relationship or identifies degrees of connection between the message sender 210 and the individuals represented in the contact list 216.

For a specific example, the social graph can indicate that the message sender 210 and the message receiver 320 are husband and wife. The contact assignment module 562 can associate the sender identifier 218 representing multimedia files of various events from their lives together. The sender identifier 218 can have a meta data of “wedding.” For example, on their anniversary date, the contact assignment module 562 can associate the sender identifier 218 representing a video clip of the husband reading his vow to the wife to the contact list 216 representing the wife. For another example, on their daughter's birthday, the contact assignment module 562 can associate the sender identifier 218 representing a digital photograph of the daughter to the contact list 216 for both the message sender 210 representing the husband and the message receiver 320 representing the wife.

For a different example, the contact assignment module 562 can associate the sender identifier 218 based on the context information 326 of the geographic information 328 of FIG. 3. For a specific example, the contact assignment module 562 can associate the sender identifier 218 based on the geographic information 328 of the message sender 210, the message receiver 320, or a combination thereof. The contact assignment module 562 can receive the geographic information 328 via the location unit 420 of FIG. 4. As discussed previously in FIG. 3, for example, the message sender 210 can be at a basketball court playing pickup basketball. The contact assignment module 562 can include the sender identifier 218 with the meta data of “sports.” Based on the geographic information 328 and the context of the geographic information 328, the contact assignment module 562 can associate the sender identifier 218 with the contact entries 212 in the contact list 216.

It has been discovered that the communication system 100 can associate the sender identifier 218 based on context information 326 surrounding the message sender 210, the message receiver 320, or a combination thereof. By determining the context information 326 of the message sender 210, the message receiver 320, or a combination thereof, the communication system 100 can accurately identify the sender identifier 218 most suited for displaying on the first device 102. As a result, customizing the sender identifier 218 according to the context enhances the user experience of using the first device 102 with the communication system 100.

The identifier classification module 554 can include a content rating module 564, coupled to the contact assignment module 562. The content rating module 564 is for determining ratings for content of media. The content rating module 564 can determine the sender content rating 560 of the sender identifier 218.

The content rating module 564 can determine the sender content rating 560 in a number of different ways. For example, the content rating module 564 can enable the message sender 210 to determine the sender content rating 560 of the sender identifier 218. As a specific example, the message sender 210 can manually determine the sender content rating 560 to be “rated R” or “Mature” when the sender identifier 218 contains depictions of violence or offensive language. In another specific example, the message sender 210 can determine the sender content rating 560 to be “rated G” or “Everyone” when the sender identifier 218 does not contain violence or offensive language.

As another example, the content rating module 564 can automatically determine the sender content rating 560 without input from the message sender 210. For example, the content rating module 564 can access external sources of information, such as the internet or ratings databases, to determine the sender content rating 560. As a specific example, if the sender identifier 218 is a video clip from YouTube™, the content rating module 564 can determine the sender content rating 560 based on ratings or evaluations made by entities that have viewed the video clip. In another specific example, if the sender identifier 218 is a video clip from a movie or film, the content rating module 564 can access a database or information source containing the rating information for the movie or film and assign the rating as the sender content rating 560.

It has been discovered that determining the sender content rating 560 for the sender identifier 218 provides improved categorization of the sender identifier 218 for transmission to the message receiver 320. As a result, the communication system 100 can accurately transmit the sender identifier 218 for improving the user experience of the first device 102 with the communication system 100.

The communication system 100 can include the communication initiation module 566. The communication initiation module 566 is for generating a request to initiate communication between devices. The communication initiation module 566 can generate a communication initiation request 570 to initiate communication between the first device 102 and another instance of the first device 102 or the second device 106.

The communication initiation request 570 is defined as a notification generated by the a device to initiate communication with another device. For example, the communication initiation module 566 can generate the communication initiation request 570 when the message sender 210 initiates a communication with the message receiver 320.

The communication system 100 can include the identifier transmission module 572. The identifier transmission module 572 is for transmitting the communication identifier when the conditions associated with the sender of the message, the receiver of the message, or a combination thereof, are satisfied. For example, the identifier transmission module 572 can transmit the sender identifier 218 to the first device 102 of the message receiver 320 for displaying on the first device 102 when transmission conditions 574 are satisfied.

The transmission conditions 574 are defined as conditions for determining whether the communication identifier can be transmitted. For example, the transmission conditions 574 can be the requirements or conditions associated with the message sender 210, the message receiver 320, or a combination thereof for transmission of the sender identifier 218. The transmission conditions 574 can include sender conditions 576 and receiver conditions 578.

The sender conditions 576 are defined as conditions associated with the sender of the communication for determining whether the communication identifier can be transmitted. For example, the sender conditions 576 can be the requirements or conditions associated with the message sender 210 for transmitting the sender identifier 218.

The receiver conditions 578 are defined as conditions associated with the receiver of the communication for determining whether the communication identifier can be transmitted. For example, the receiver conditions 578 can be the requirements or conditions associated with the message receiver 320 for transmitting the sender identifier 218.

The identifier transmission module 572 can determine satisfaction of the sender conditions 576 with a sender condition verification module 580. The sender condition verification module 580 is for determining when the classification of the communication identifier corresponds to conditions for transmission. The sender condition verification module 580 can determine satisfaction of the transmission conditions 574 when the media classification 556 of the sender identifier 218 corresponds at least with the sender conditions 576.

The media classification 556 corresponds with the sender conditions 576 when the contact classification 558 of the media classification 556 corresponds with or matches the contact information 214 of FIG. 2 of the message receiver 320; the sender content rating 560 of the media classification 556 corresponds with or matches a content threshold 586 of the sender conditions 576; or a combination thereof.

The content threshold 586 is defined as a threshold for determining whether the content of the communication identifier is appropriate for transmitting to the receiver of the message. The content threshold 586 can be based on a receiver content rating 584 deemed appropriate for the message receiver 320 accepting or receiving the sender identifier 218.

The receiver content rating 584 can be an established or commonly used rating system such as the Motion Picture Association of America (MPAA) rating system, the Entertainment Software Rating Board (ESRB) rating system, or a rating system determined by the message sender 210. For example, the content threshold 586 can be “Rated R” when the receiver content rating 584 indicates that depictions of violence or mature language is used in the sender identifier. The content threshold 586 can be linked with the contact information 214 of the message receiver 320.

The content threshold 586 can be determined in a number of different ways. For example, the message receiver 320 can provide the content threshold 586 through notification, such as through a feedback or communication through a website accessible to both the message sender 210, the first device 102, the second device 106, the message receiver 320, or a combination thereof. In another example, the content threshold 586 can be determined by the message sender 210. As a specific example, the message sender 210 can determine the content threshold 586 to have a “general (G) audience” or an “Everyone (E)” rating for the contact information 214 associated with the child or grandparent of the message sender 210.

For further example, the content threshold 586 can base on the profile of the message receiver 320. More specifically, if the message receiver 320 is 16 years old, the content threshold 586 can be set for the message receiver 320 to receive the sender identifier 218 with the receiver content rating 584 between “G rated” and “PG-13” rating. For a different example, if the geographic information 328 of the message receiver 320 can represent an elementary school, the content threshold 586 can be set so that the message receiver 320 can receive the sender identifier 218 with the receiver content rating 584 between “G rated” or “Everyone (E)” rating.

The sender condition verification module 580 can include a contact verification module 582. The contact verification module 582 is for determining when classifications associated with the communication identifier matches or corresponds with information related to a contact. For example, the contact verification module 582 can determine when the contact classification 558 corresponds with or matches the contact information 214 of the message receiver 320 with a contact verification module 582.

As an example, the contact verification module 582 can determine whether the contact information 214 of the message receiver 320 is the same as or is included in the contact classification 558 of the media classification 556 when the message sender 210 initiates communication with the first device 102. As a specific example, during telephonic communication between the message sender 210 and the message receiver 320, the contact verification module 582 can compare the telephone number input into the first device 102 with the telephone number in the contact information 214 associated with the message receiver 320.

The sender condition verification module 580 can include a content threshold module 588, coupled to the contact verification module 582. The content threshold module 588 is for determining when the content rating corresponds with a threshold. The content threshold module 588 can determine when the sender content rating 560 corresponds with the content threshold 586. As an example, the content threshold module 588 can determine when the sender content rating 560 corresponds with the content threshold 586 based on a comparison between the content threshold 586 and the sender content rating 560.

For example, the content threshold module 588 can determine the sender content rating 560 corresponds with the content threshold 586 when the sender content rating 560 is below the content threshold 586. As a specific example, when the content threshold 586 is “R rated” and the sender content rating 560 is “G rated”, which is below “R rated”, the content threshold module 588 can determine the sender content rating 560 corresponds with the content threshold 586.

It has been discovered that the communication system 100 can transmit the sender identifier 218 most appropriate to the message receiver 320 based on comparing the sender content rating 560 to the content threshold 586. By comparing the sender content rating 560 to the content threshold 586, the content threshold module 588 can accurately determine the sender identifier 218 most suited for displaying on the first device 102. As a result, customizing the sender identifier 218 based on the permitted content enhances the user experience of using the first device 102 with the communication system 100.

The identifier transmission module 572 can include a receiver condition verification module 590, coupled to the sender condition verification module 590. The receiver condition verification module 590 is for determining satisfaction of conditions associated with the receiver of the message. The receiver condition verification module 590 can determine satisfaction of the receiver conditions 578.

The receiver conditions 578 can be based on a receiver status 592 of the message receiver 320, a receiver device status 594, or a combination thereof. The receiver condition verification module 590 can determine when the receiver conditions 578 are satisfied when the receiver status 592, the receiver device status 594, or a combination thereof indicate availability.

The receiver status 592 is defined as the status of the receiver of the communication identifier at the time transmission is attempted. The receiver status 592 can be an indicator of when the message receiver 320 is capable or willing to receive the sender identifier 218.

For example, the receiver status 592 can indicate availability when the message receiver 320 is not distracted or occupied. In another example, the receiver status 592 indicate unavailability when the message receiver 320 is occupied or distracted, such as when the message receiver 320 is in a meeting, driving a vehicle, asleep, or otherwise unable or unwilling to receive the sender identifier 218.

The receiver device status 594 is defined as factors or conditions associated with the device designated to receive the communication identifier. The receiver device status 594 can be an indicator of when the first device 102 of the message receiver 320 is capable of receiving or unable to receive the sender identifier 218.

For example, the receiver device status 594 can indicate availability when the first device 102 of the message receiver 320 is powered on or able to receive data or information. In another example, the receiver device status 594 can indicate unavailability when the first device 102 of the message receiver 320 is low on power or when the data transfer or download allowance for the message receiver 320 has exceeded or is near exceeding the limit. For further example, the receiver device status 594 can indicate intermittent availability when the first device 102 of the message receiver 320 is in a geographic region where the network signal is weak. For another example, the receiver device status 594 can indicate unavailability when the second device 106 is down for transmitting the sender identifier 218.

The receiver status 592 and the receiver device status 594 can be determined in a number of different ways. For example, the message receiver 320 can provide the receiver status 592 and the receiver device status 594 through notification, such as through a feedback or communication through a website accessible to both the message sender 210, the message receiver 320, the first device 102, the second device 106, or a combination thereof.

It has been discovered that the receiver condition verification module 590 improves communication between the message sender 210 and message receiver 320 by preventing or allowing transmission of the sender identifier 218 when the receiver conditions 578 are satisfied. As a result, the communication system 100 can transmit the sender identifier 218 efficiently for the improved user experience for using the first device 102 with the communication system 100.

The identifier transmission module 572 can transmit the sender identifier 218 to the first device 102 of the message receiver 320 in conjunction with the communication initiation request 570 when the media classification 556 satisfies the sender conditions 576, when the receiver conditions 578 are satisfied, or a combination thereof. The sender identifier 218 is for displaying on the second device 106.

As an example, in the case when the communication 100 implements the communication initiation module 566 to generate multiple ones of the communication initiation request 570, such as during a conference call, a multicast, or party line telephone call, the communication system 100 can dynamically transmit the sender identifier 218 based on the sender content rating 560, the receiver content rating 584, or a combination thereof. As a specific example, the identifier transmission module 572 can transmit the sender identifier 218 having the sender content rating 560 that is common among the receiver content rating 584 for each of the message receiver 320. In yet another specific example, the identifier transmission module 572 can transmit the sender identifier 218 having the sender content rating 560 of “G rated” when one of the receiver content rating 584 is “R rated” and another one of the receiver content rating 584 is “G rated”.

The communication system 100 can include an identifier adjustment module 596. The identifier adjustment module 596 is for adjusting the communication identifier based on the limitations or capability of the device receiving the communication identifier. For example, the identifier adjustment module 596 can adjust aspects or properties of the sender identifier 218 based on a device capability 598 of the second device 106.

The device capability 598 is defined as the limitations or capability of the device receiving the communication identifier. For example, the device capability 598 can be the rate at which the first device 102 of the message receiver 320 can receive information or data. As another example, the device capability 598 can be dimensions or aspect ratio of the first display interface 430 of FIG. 4 of the first device 102 of the message receiver 320. In yet another example, the specifications or capability of the graphics processor associated with the first control unit 412 of FIG. 4 of the first device 102 of the message receiver 320.

The device capability 598 can be determined in a number of different ways. For example, the device capability 598 can be transmitted from the first device 102 of the message receiver 320 to the first device 102 of the message sender 210. As another example, the device capability 598 can be posted through notification, such as through a feedback or communication through a website accessible to both the message sender 210, the message receiver 320, the first device 102, the second device 106, or a combination thereof.

The identifier adjustment module 596 can adjust or modify the sender identifier 218 in a number of different ways. For example, the identifier adjustment module 596 can reduce the video quality of the sender identifier 218 when the first device 102 of the message receiver 320 is only capable of low data or information transfer rates. As another example, the identifier adjustment module 596 can adjust the video aspect ratio of the sender identifier 218 to match that of the first display interface 430.

It has been discovered that the identifier adjustment module 596 improves transmission of the sender identifier 218 adjusting the properties of the sender identifier 218 based on the device capabilities 598. By adjusting the properties of the sender identifier 218 based on the device capabilities 598, the communication system 100 can efficiently transmit the sender identifier 218 to the first device 102. As a result, adjusting the sender identifier 218 according to the device capabilities 598 enhances the user experience of using the first device 102 with the communication system 100.

The communication system 100 can be partitioned between the first device 102 of FIG. 4 and the second device 106 of FIG. 4. For example, the communication system 100 can be partition into the functional units of the first device 102, the second device 106, or a combination thereof. The communication system 100 can also be implemented as additional functional units in the first device 102, the second device 106, or a combination thereof.

The physical transformation from traveling from one geographic location to another results in movement in the physical world, such as people using the first device 102, the second device 106, or a combination thereof, based on the operation of the communication system 100. As the movement occurs, the movement itself creates additional contextual and geographic information 328 that is converted back into changes in the sender identifier 218 to be displayed on the first device 102 for the continued operation of the communication system 100 and to continue the movement in the physical world.

The communication system 100 can be implemented on the first device 102, on the second device 106, or partitioned between the first device 102 and the second device 106. In an example for the first device 102, the first software 426 of FIG. 4 of the first device 102 can include the identification management module 550, the communication initiation module 566, the identifier transmission module 572, and the identifier adjustment module 596. The first control unit 412 of FIG. 4 can execute the first software 426. For example, the first control unit 412 can implement the identifier transmission module 572 to transmit the sender identifier 218 with the first communication unit 416 of FIG. 4.

In an example for the second device 106 of FIG. 4, the second software 442 of FIG. 4 can include the communication system 100. For example, the second software 442 can include the identification management module 550, the communication initiation module 566, the identifier transmission module 572, and the identifier adjustment module 596. The second control unit 434 can execute the second software 442. For example, the second control unit 434 can implement the identifier transmission module 572 to transmit the sender identifier 218 with the second communication unit 436 of FIG. 4.

In another example, the communication system 100 can be partitioned between the first software 426 and the second software 442. For example, the sender identifier 218 can be stored on the second storage unit 446 of FIG. 4. As a further example, the identification management module 572, the communication initiation module 566, and the identifier transmission module 572 can be stored in the first storage unit 414 of FIG. 4 and the identifier adjustment module 596 can be stored on the second storage unit 446.

The modules, such as the identification management module 550, the communication initiation module 566, the identifier transmission module 572, and the identifier adjustment module 596, can be implemented within the first control unit 412 or in the second control unit 434 as hardware accelerators. The modules can be implemented in hardware in the first device 102 or the second device 106 outside the first control unit 412 or the second control unit 434, respectively.

The communication system 100 describes the module functions or order as an example. The modules can be partitioned differently. Each of the modules can operate individually and independently of the other modules. Furthermore, data generated in one module can be used by another module without being directly coupled to each other.

In the communication system 100, as an example, each module is indicated by a number and successively higher module numbers follow one another. Control flow can pass from one module to the next higher numbered module unless explicitly otherwise indicated. The identification management module 550, the communication initiation module 566, the identifier transmission module 572, and the identifier adjustment module 596 can be implement in as hardware (not shown) within the first control unit 412, the second control unit 434, or special hardware (not shown) in the first device 102 or the second device 106.

Referring now to FIG. 6, therein is shown a flow chart of a method 600 of operation of a communication system 100 of FIG. 1 in a further embodiment of the present invention. The method 600 includes: determining a media classification associated with a sender identifier in a block 602; associating the sender identifier with a contact entry based on context information in a block 604; and transmitting the sender identifier based on the media classification corresponding to a transmission condition for displaying on a device in a block 606.

As examples, the sender identifier can be based on a sender content rating corresponding with a sender condition of the transmission condition or with receiver conditions. As a more specific example, the sender identifier based on a receiver status associated with a receiver condition indicating an availability or with a receiver condition of the transmission condition indicating an availability. The sender identifier can be customized with geographic information.

The media classification can include a contact classification, with which sender identifier can be transmitted based on the contact classification corresponding to the transmission condition. The media classification can also include a sender content rating, which can be used to determine the media classification.

Thus, it has been discovered that the communication system and device of an embodiment of the present invention furnishes important and heretofore unknown and unavailable solutions, capabilities, and functional aspects for identification management. The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance. These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A communication system comprising:
an identifier classification module configured to determine a media classification associated with a sender identifier;
a contact assignment module, coupled to the identifier classification module, configured to associate the sender identifier with a contact entry based on context information; and
an identifier transmission module, coupled to the contact assignment module, configured to transmit the sender identifier based on the media classification corresponding to a transmission condition for displaying on a device.

2. The system as claimed in claim 1 wherein the identifier transmission module is configured to determine transmitting the sender identifier based on a sender content rating corresponding with a sender condition of the transmission condition.

3. The system as claimed in claim 1 wherein:
the contact assignment module is configured to determine a contact classification; and
the identifier transmission module is configured to transmit the sender identifier based on the contact classification corresponding to the transmission condition.

4. The system as claimed in claim 1 wherein the identifier transmission module is configured to transmit the sender identifier based on a sender content rating corresponding with a content threshold of the sender condition.

5. The system as claimed in claim 1 wherein the identifier transmission module is configured to transmit the sender identifier based on corresponding with receiver conditions.

6. The system as claimed in claim 1 wherein the identifier classification module is configured to determine a media classification, including a sender content rating, associated with the sender identifier.

7. The system as claimed in claim 1 wherein the contact assignment module is configured to associate the sender identifier based on the geographic information for customizing the sender identifier displayed on the device.

8. The system as claimed in claim 1 wherein the identifier transmission module includes a content threshold module configured to determine the sender content rating meeting or dipping below a content threshold.

9. The system as claimed in claim 1 wherein the identifier transmission module is for transmitting the sender identifier based on a receiver status associated with a receiver condition indicating an availability.

10. The system as claimed in claim 1 wherein the identifier transmission module is configured to transmit the sender identifier based on a receiver device status associated with a receiver condition of the transmission condition indicating an availability.

11. A method of operation of a communication system comprising:
determining a media classification associated with a sender identifier;
associating the sender identifier with a contact entry based on context information; and
transmitting the sender identifier based on the media classification corresponding to a transmission condition for displaying on a device.

12. The method as claimed in claim 11 wherein transmitting the sender identifier includes transmitting the sender identifier based on a sender content rating corresponding with a sender condition of the transmission condition.

13. The method as claimed in claim 11 wherein:
determining the media classification includes determining a contact classification; and
transmitting the sender identifier includes transmitting the sender identifier based on the contact classification corresponding to the transmission condition.

14. The method as claimed in claim 11 wherein transmitting the sender identifier includes transmitting the sender identifier based on a sender content rating corresponding with a content threshold of the sender condition.

15. The method as claimed in claim 11 wherein transmitting the sender identifier includes transmitting the sender identifier based on corresponding with receiver conditions.

16. The method as claimed in claim 11 wherein comprising the media classification includes a sender content rating.

17. The method as claimed in claim 11 wherein associating the sender identifier includes associating the sender identifier based on geographic information for customizing the sender identifier displayed on the device.

18. The method as claimed in claim 11 wherein determining the media classification includes determining the sender content rating meeting or dipping below a content threshold.

19. The method as claimed in claim 11 wherein transmitting the sender identifier includes transmitting the sender identifier based on a receiver status associated with a receiver condition indicating an availability.

20. The method as claimed in claim 11 wherein transmitting the sender identifier includes transmitting the sender identifier based on a receiver device status associated with a receiver condition of the transmission condition indicating an availability.
